(19) United States
(12) Patent Application Publication
(10) Pub. No.: US 2014/0156626 A1
(43) Pub. Date: Jun. 5, 2014

(54) EMBEDDED EXTERNALLY HOSTED CONTENT IN SEARCH RESULT PAGE

(71) Applicant: MICROSOFT CORPORATION, Redmond, WA (US)

(72) Inventors: Franco Salvetti, San Francisco, CA (US); Justin John Trobec, Fremont, CA (US); Gianluca Donato, Los Altos, CA (US)

(73) Assignee: MICROSOFT CORPORATION, Redmond, WA (US)

(21) Appl. No.: 13/691,707

(22) Filed: Nov. 30, 2012

(51) Int. Cl. G06F 17/30

(52) U.S. Cl. CPC G06F 17/30864
USPC 707/709

(57) ABSTRACT

Architecture that enables user interaction in a search engine results page (SERP) with externally hosted content. A control hosted by an external data source is seamlessly embedded within the SERP, and then functions transparently as if the control were an internally hosted control. The architecture includes the capability to trigger the addition of the control to the SERP, embed the control within the SERP, and enable the control to interact with the SERP. To seamlessly embed the external control, a key is created that uniquely identifies the external control. The key is encoded and injected into the web document index. At query time, the key is detected and causes a link to be rendered within the SERP. When the querying user selects on the link, other elements in the SERP are moved aside to make room for the external control.

### BACKGROUND

The enormous amount of data available for searching continues to increase unabated, thereby making the prospect of finding the desired information a daunting process. In web search, multimedia content is increasingly becoming more desirable than simply textural content, since images, video, and audio, for example, provide rich information over simply textual information. However, the content is dispersed over many different websites and other data sources. A heretofore desirable and unrealized capability is to enable functionality in the search results page that, while transparent to the user, enables the user to interact with externally hosted content.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture solves the problem of enabling the user to interact with externally hosted content. A control hosted by an external data source is seamlessly embedded within a search engine results page (SERP), and then functions transparently as if the control were an internally hosted control. The architecture includes the capability to trigger the addition of the control to the SERP, embed the control within the SERP, and enable the control to interact with the SERP.

In order to seamlessly embed the external control, a key is created that uniquely identifies the external control. The key is encoded and injected into the web document index. At query time, the key is detected and causes a link to be rendered within the SERP. When the querying user selects on the link, other elements in the SERP are moved aside to make room for the external control. New SERPs are opened in response to user interaction with the control.

Injection of the keys that identify the controls is accomplished by providing a list of links (e.g., URL-uniform resource locators) paired with keys to a crawler component (an automated indexing software program that methodically and automatically browses the web for documents) that crawls the web for documents ultimately included in an index. As the crawler picks up a document from the web, it checks to see if the document URL is in the link-keys list. If so, the key is injected as structured content into the document as the document is stored in a web repository.

At query time, when documents are served in response to a user query, if the document contains an injected key, the key is used to populate a control within the SERP. The control specifically uses this key as a portion of a URL linking to specific, interactive content hosted on an external site.

When the user interacts with (selects, clicks) the control, other content on the SERP is pushed aside (displaced), and the user's browser is instructed to render the external control in an iframe within the page. This control enables the user to execute further searches by exposing click targets that open new tabs prepopulated with related searches, maps, or other content. An alternative way to accomplish the resolution of the external key can be to look-up the key in an online key value store at query time.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a system where the list of pairs is created by the list component.

FIG. 3 illustrates a system that relates identifiers to external controls of external web sources.

FIG. 4 illustrates a system that indexes identifiers and document location information.

FIG. 5 illustrates a search result decorated with a control as presented in a SERP of a user interface.

FIG. 6 illustrates the search result as viewed with presentation of the video content in the user interface of a browser after selection of the control.

FIG. 7 illustrates an alternative embodiment where interaction with the control of FIG. 5 results in rendering of content of an inner SERP within a control iframe constructed for the control of the main SERP.

FIG. 8 illustrates a flow diagram for embedding externally hosted content in a search engine results page.

FIG. 9 illustrates a method in accordance with the disclosed architecture.

FIG. 10 illustrates an alternative method in accordance with the disclosed architecture.

FIG. 11 illustrates a block diagram of a computing system that executes the embedding of externally hosted content in a search engine results page in accordance with the disclosed architecture.

### DETAILED DESCRIPTION

The disclosed architecture enabled a user to interact with externally hosted content. A control hosted by an external data source is seamlessly embedded within a search engine results page (SERP), and then functions transparently as if the control were an internally hosted control. The architecture includes the capability to trigger the addition of the control to the SERP, embed the control within the SERP, and enable the control to interact with the SERP.

In order to seamlessly embed the external control, a key is created that uniquely identifies the external control. The key is encoded and injected into the web document index. At query time, the key is detected and causes a link to be rendered within the SERP. When the querying user selects on the link, other elements in the SERP are moved aside to make room for the external control. New SERPs can be opened in response to user interaction with the control.

A list of links (e.g., URL-uniform resource locators) paired with keys (identifiers) are provided to a crawler component (an automated indexing software program that methodically and automatically browses the web for documents) that crawls the web for documents ultimately to be included in an index. As the crawler picks up a document from the web, it checks to see if the document URL is in the link-keys list. If so, the key is injected as structured content into the document as the document is stored in a web repository.

At query time, when documents are served in response to a user query, if the document contains an injected key, the key is used to populate a control within the SERP. The control specifically uses this key as a portion of a URL linking to specific, interactive content hosted on an external site.

When the user interacts with (selects, clicks) the control, other content on the SERP is pushed aside (displaced), and the user's browser is instructed to render the external control in an iframe within the page. This control enables the user to execute further searches by exposing click targets that open new tabs prepopulated with related searches, maps, or other content. An alternative way to accomplish the resolution of the external key can be to look-up the key in an online key value store at query time.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

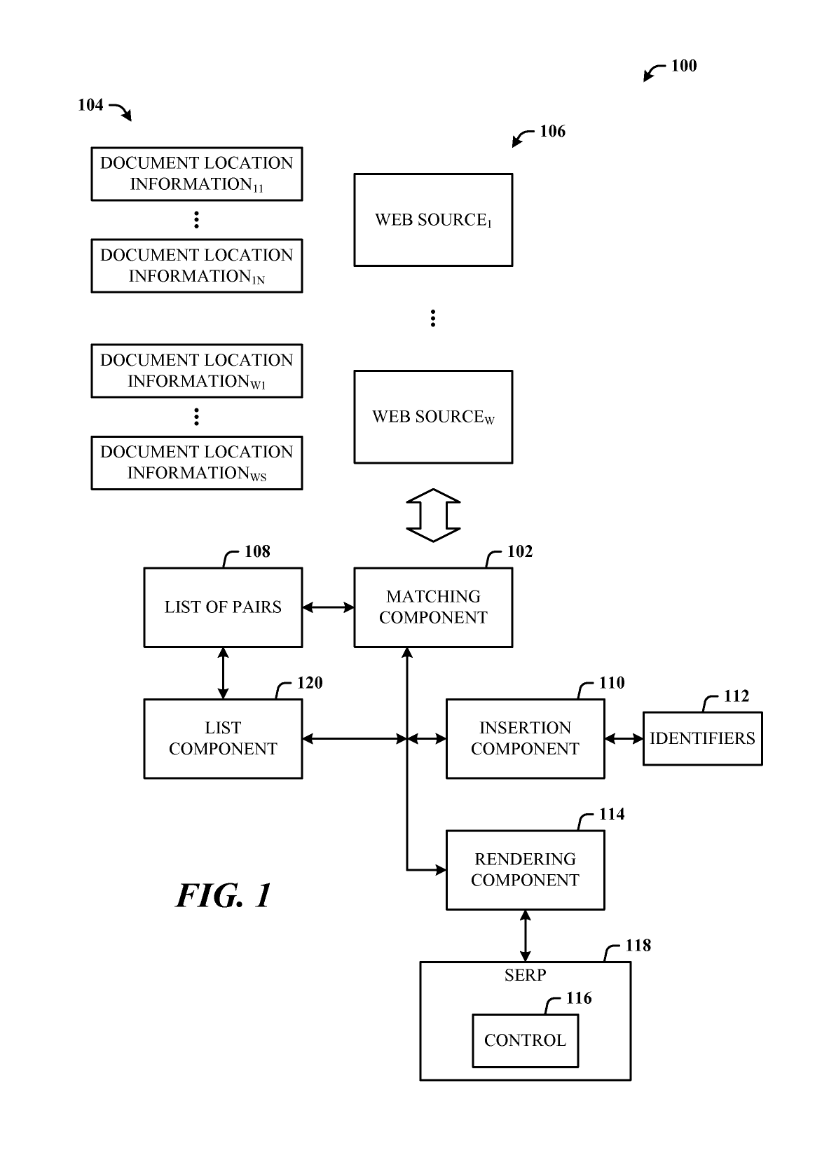

FIG. 1 illustrates a system 100 in accordance with the disclosed architecture. The system 100 can include a matching component 102 that matches crawled document location information 104 (denoted Document Location Information_{11-1N} . . . Document Location Information_{W1-WS}, where S is the number of web sources, N is the number of location information items for a first web source and S is the number of location information items for the w^{th} web source) of crawled web sources 106 (denoted Web Source₁ . . . Web Source_{W}) to listed document location information of a list 108 of listed document-location-information-to-identifier(key) pairs. The document location information can be URLs (uniform resource locators) for each document of a web source, and thus, there are many different instances of the document location information (DLI) across myriad web sources (e.g., websites, document repositories, etc.).

An insertion component 110 inserts an identifier (of identifiers 112) into a specific web document as part of storing the specific web document. The identifier insertion can be based on the successful match between the crawled document location information 104 and the listed document location information (of the list 108). In other words, when the matching component 102 successfully matches an instance of a crawled document location information to an instance of a listed document location information, the identifier is inserted into the document or URL associated with the crawled document.

The system 100 can further comprise a rendering component 114 that renders an external control 116 in a search engine results page 118 when the identifier is detected at query time. The rendering component 114 pushes aside elements of a search result on the search engine results page (SERP) 118 to render content associated with the specific web document. The search result is associated with the external control 116. The rendering component 114 also pushes aside elements of a search result on the search engine results page 118 to render another search result page of content. In other words, the depth of integration is limited only by the amount of visual real estate (pixels) of the display. The matching component 102 can be part of a web indexing component (indexer) that indexes the identifiers into an index of web documents. The system 100 can further comprise a list component 120 for creating the list 108 of pairs of corresponding to specific web documents. The specific web documents can be hosted on specific web sources (of the web sources 106).

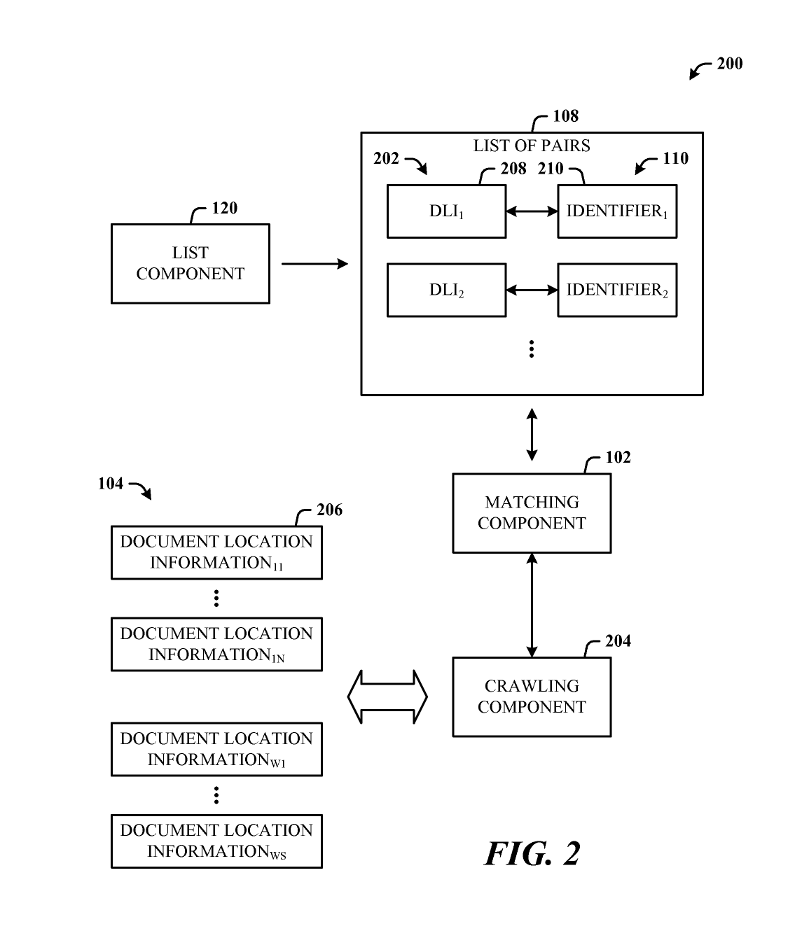

FIG. 2 illustrates a system 200 where the list 108 of pairs is created by the list component 120. The listed DLI's 202 can be URLs mapped in a 1-to-1 relationship to the identifiers 112. The list 108 can be formulated prior to the crawling process. Thus, as the crawling process occurs, using a crawling component 204, the list 108 is referenced to match the crawled DLI's 104 against the listed DLI's 202. For example, if DLI₁₁ 206 (of the crawled DLI's 104) is matched to DLI₁ 208 (of the listed DLI's 202), the identifier 210 (of the identifiers 110) is used to further relate to a control (not shown) for interacting with the related search result.

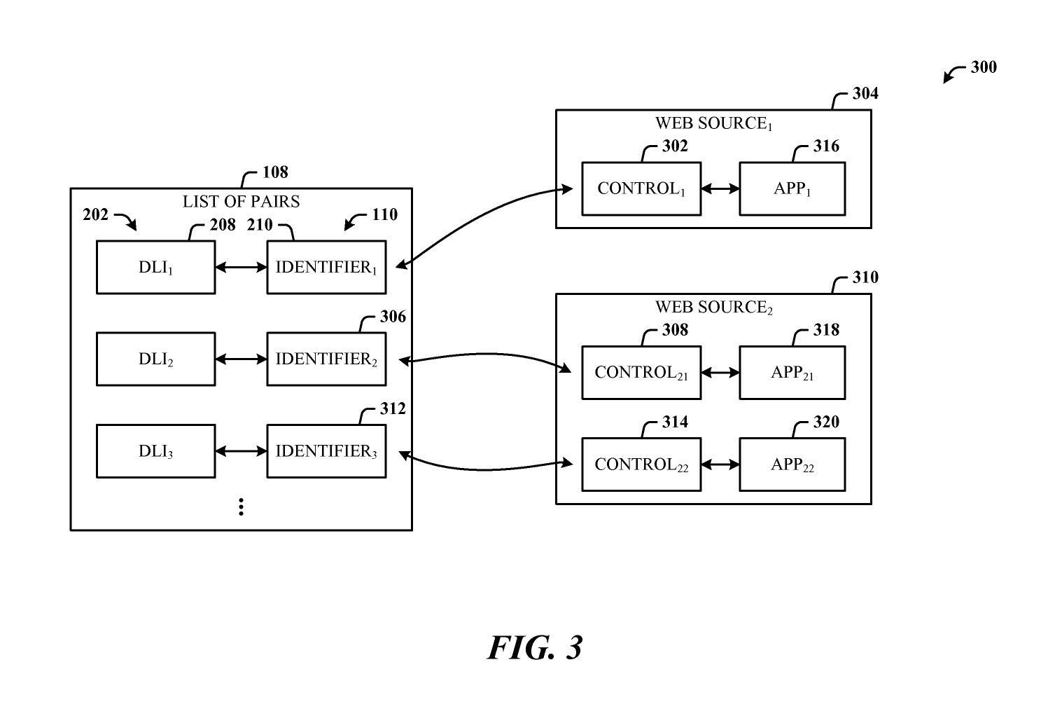

FIG. 3 illustrates a system 300 that relates identifiers 110 to external controls of external web sources. Here, the list 108 of pairs includes the identifier 210 that relates to a first external control 302 of a first web source 304, a second identifier 306 that relates to a second external control 308 of a second web source 310, and a third identifier 312 that relates to a third external control 314 of the second web source 310.

The first external control 302 can be related to a first application 316 such that selection of the first external control 302 facilitates the launch and running of content referred to in the search results of the SERP. For example, if the search result includes the first external control 302 as presented by a browser, for example, user interaction with (selection of) the first external control 302 causes remote execution of the first application 316 to run the content. In a more specific example, the first external control 302 is related to a video execution application that executes a specific video content instance when the user selects the first external control 302.

The second external control 308 can be related to a second application 318 such that selection of the second external control 308 facilitates the launch and running of content referred to in the search results of the SERP. For example, if the search result includes the second external control 308 as presented by a browser, for example, user interaction with (selection of) the second external control 308 causes remote execution of the second application 318 to run the content. Similarly, the third external control 314 can be related to a third application 320 of the second web source 310 such that selection of the third external control 314 facilitates the launch and running of content referred to in the search results of the SERP. For example, if the search result includes the third external control 314 as presented by a browser, for example, user interaction with (selection of) the third external control 314 causes remote execution of the third application 320 to run the content.

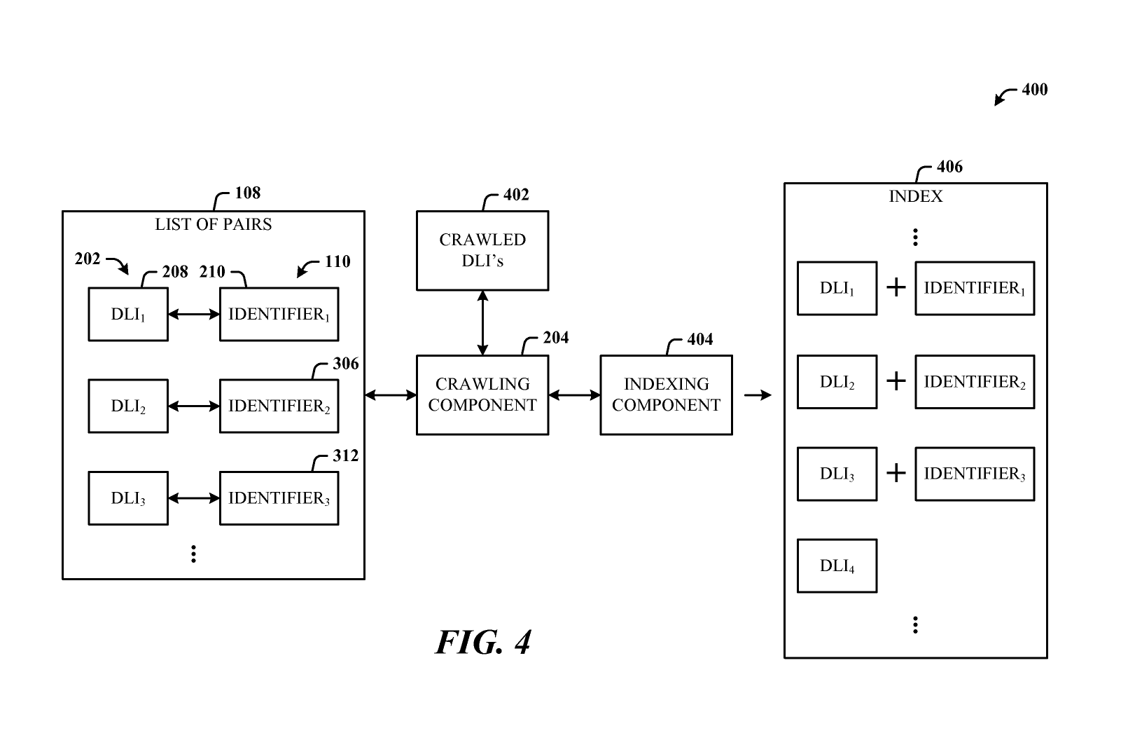

FIG. 4 illustrates a system 400 that indexes identifiers and document location information. The list 108 has been described herein above. The crawling component 204 (crawler) compares (performs a matching operation) the listed DLI's 202 to crawled DLI's 402. Any successful matches where a crawled DLI matches a listed DLI results in the crawling component 204 passing the related pair from the list 108 to an indexing component 404 for indexing into an index 406. Here, three matches are determined, resulting in three of the pairs being indexed into the index 406: the DLI₁-Identifier₁ pair, the DLI₂-Identifier₂ pair, and the DLI₃-Identifier₃ pair.

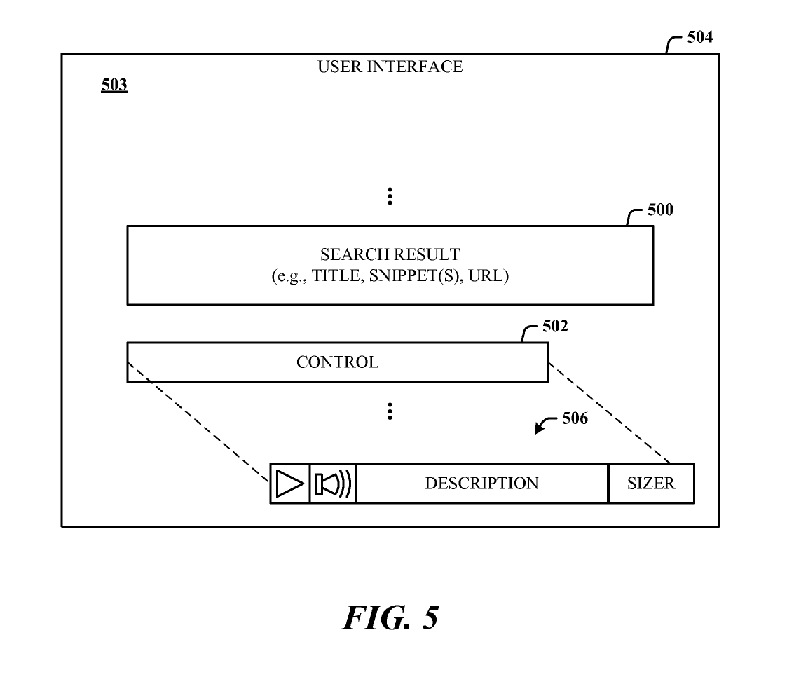

FIG. 5 illustrates a search result 500 decorated with a control 502 as presented in a SERP 503 of a user interface 504 (e.g., of a browser). The decoration process adds the control 502 (e.g., a link) in association with the search result 500 on the SERP 503, such as immediately below the search result 500, to the right of result, etc., so that the viewer understands the control 502 is associated with the given result. The search result 500 includes commonly employed elements such as the linkable title, one or more snippets of text that provide a piece or pieces of text content from the associated webpage, and a link (e.g., URL) to the webpage (web document).

In this particular example, the content can include a video. Accordingly, the control 502 facilitates the play of the video content in the browser from the external web source (and not from navigation to another web document related to the search result 500).

In an alternative implementation, the control 502 can be a set of controls 506 that facilitate controlling play, pause, rewind, etc., an audio control for controlling volume of an audio system, an annotated (description) control that when selected retrieves the video content from a storage location, and a video sizer that expands the video being played to full screen (full size) or a reduces the video to a default view (default size) screen. The control 502 can be defined by metadata that is indexed by the search framework with the location information.

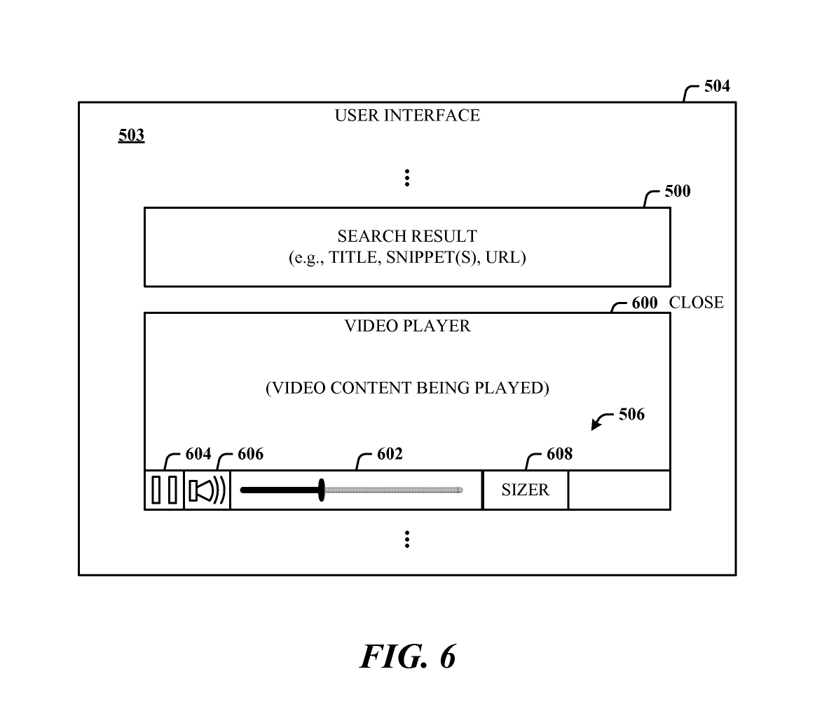

FIG. 6 illustrates the search result 500 as viewed with presentation of the video content in the user interface 504 of a browser after selection of the control 502. The user interface 504 (e.g., a browser) is instructed to render the control 502 in an iframe within the viewed SERP 503. Once selected, the control 502 is replaced in the view with a player 600 that plays the video content. This results in the vide o player 600 taking increased space proximate the associated search result 500. Accordingly, certain elements of the SERP 503 are moved aside to fit the video player 600 to a size that enables viewing of the video content at a suitable viewing size.

Additionally, the control 502 can be changed to the set of controls 506, which are suitable for user interaction with the video player 600, such as a player progress bar 602 that tracks and shows play progress of the video content, a play control 604 that switches to a pause indication, should the user choose to pause play, an audio control 606 for controlling volume of an audio system, and a video sizer 608 that enables the user to vary the display size of the video player (e.g., switch between full screen and a default screen size).

The player 600 can be downloaded from the web source or other location for play of a proprietary format of the video content (if the video content is transformed into a proprietary format), or be a commonly installed local player that automatically launches in response to selection of the indicator 502 (if the video content is of a commonly-used format).

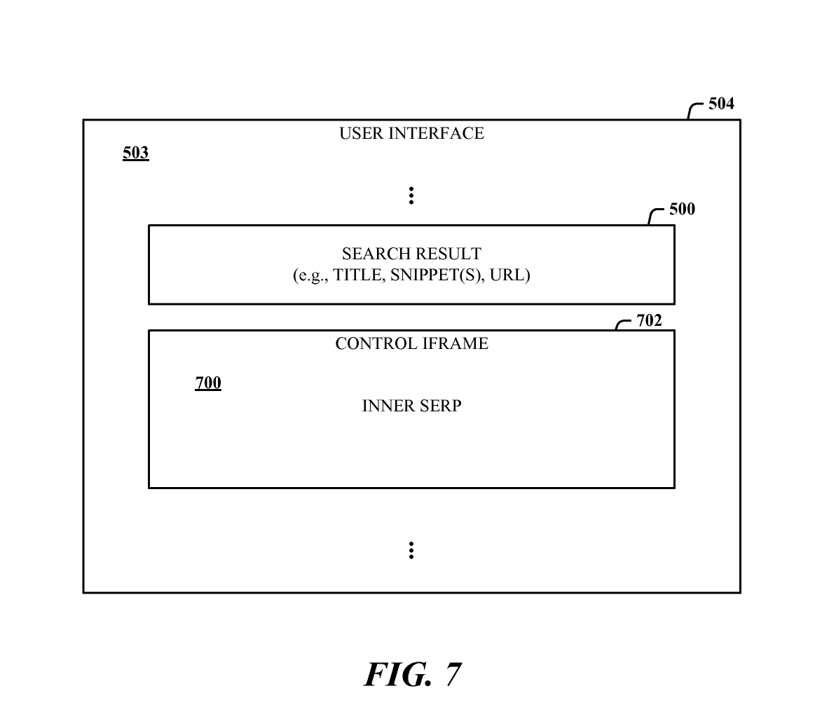

FIG. 7 illustrates an alternative embodiment where interaction with the control 502 of FIG. 5 results in rendering of content of an inner SERP 700 within a control iframe 702 constructed for the control 502 of the main SERP. In this way, the user can continue to interact with controls associated with deeper layers of SERPs and/or content. In accordance therewith, the user interface 504 is continually instructed (e.g., by a rendering program) to move main SERP elements aside to make room for the additional inner SERPs and selected content. The elements can include, but are not limited to, other search results, pieces of the associated search result (e.g., title, URL, snippet(s)). This displacement of elements can continue in the inner SERP 700 in response to the content to be displayed and adjusts based on the display needs. It can be the case that the amount of space allocated for overall displacement for the search result 500 is restricted such that the displacement does not consume the entire main SERP 503, although this is not a requirement.

Put another way, the system comprises a rendering component that renders an external control (the control 502) in a search engine results page (SERP 503) when the identifier is detected at query time. The rendering component pushes aside elements of a search result on a search engine results page to render content associated with the specific web document, the search result associated with the external control. The rendering component pushes aside elements of a search result on a search engine results page to render another search results page of content. The matching component can be part of a web indexing component that indexes the identifier into an index of web documents.

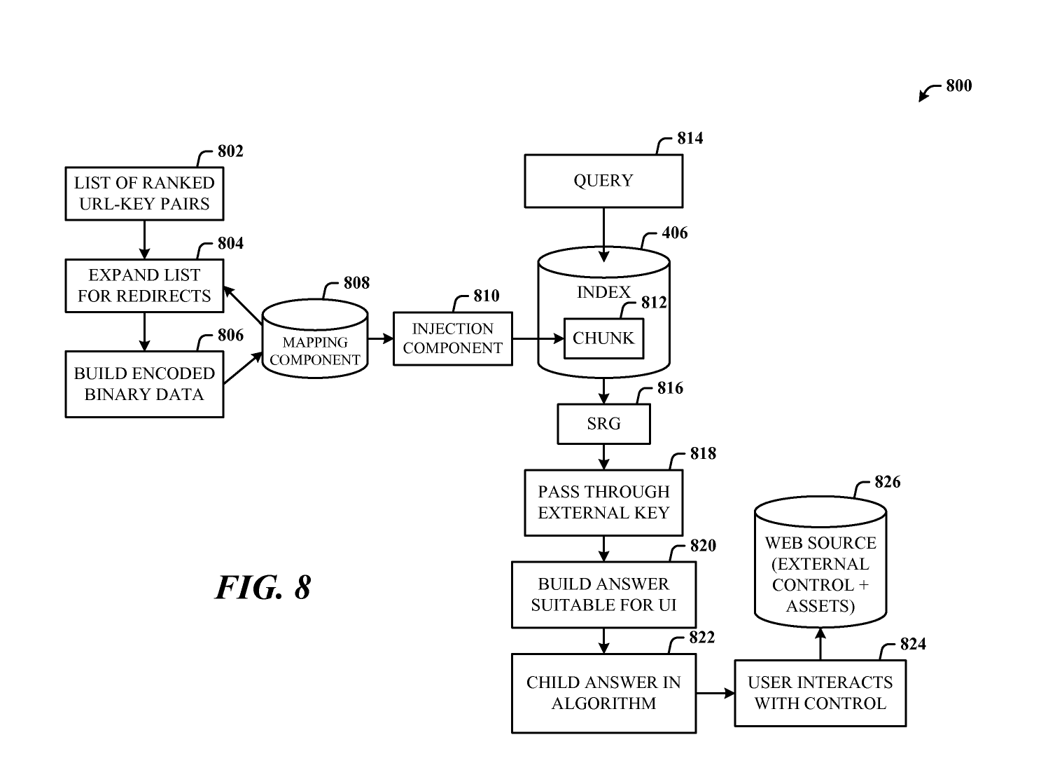

FIG. 8 illustrates a data flow diagram 800 for embedding externally hosted content in a search engine results page. At 802, the list of URL-keys is generated. This can be a ranked list according to various ranking criteria. At 804, the list can be expanded based on the number of redirects observed. A redirect is a technique of URL forwarding for making a webpage available under more than a single URL address.

At 806, binary encoded data is built for processing by a mapping component 808 (also referred to herein as the list component 120). This binary data triggers exposure of the control on the SERP. The injection component 810 inserts binary data of the identifier and URL (also called document location information) into the index 406, indicated as a chunk 812.

A query 814 is received and processed against the index 406, the output of which are documents that are sent to a search result generator (SRG) 816, which looks at the documents are query time to extract metadata. The metadata includes the key (identifier) which is extracted and passed through, at 818, to build an answer in a format suitable for the user interface, at 820. The answer is output as a control for the UI in association with the search result, at 822, and linked to the corresponding web source. At 824, the user interacts with the control. The control interaction pulls in an external control and assets from the related web source.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

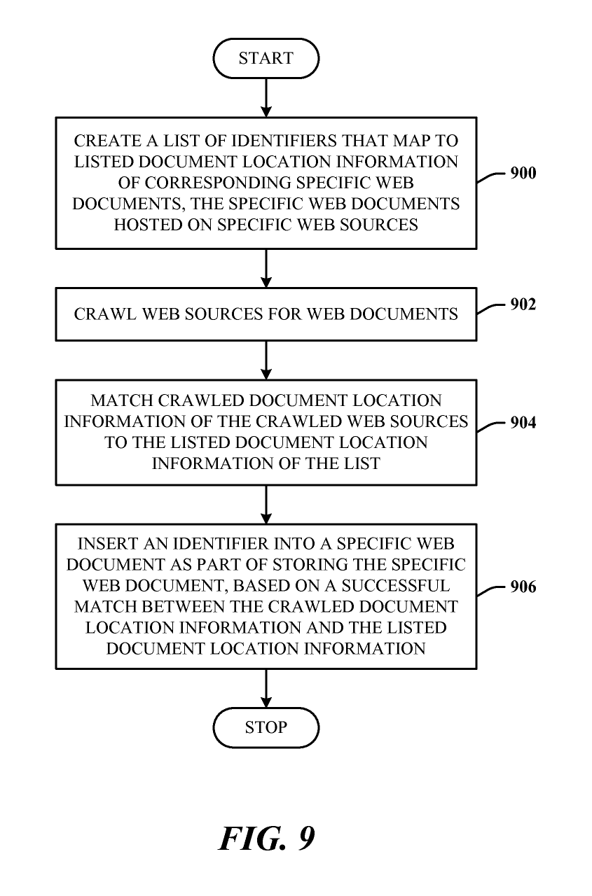

FIG. 9 illustrates a method in accordance with the disclosed architecture. At 900, a list of identifiers that map to listed document location information of corresponding specific web documents is created. The specific web documents are hosted on specific web sources. At 902, web sources are crawled for web documents. At 904, crawled document location information of the crawled web sources is matched to the listed document location information of the list. At 906, an identifier is inserted into a specific web document as part of storing the specific web document, based on a successful match between the crawled document location information and the listed document location information.

The method can further comprise relating the identifier to an external control associated with an external specific web document, and rendering the external control in a search engine results page when the identifier is detected at query time. The method can further comprise employing the identifier in association with the listed document location information to link the control to interactive content hosted on the specific web source.

The method can further comprise visually pushing aside other content of a search result to render the specific web document associated with the identifier, and also visually pushing aside the other content and the specific web document to render still other content in association with the search result based on selection of still another control. The method can further comprise visually pushing aside other content of a search result to render another search results page.

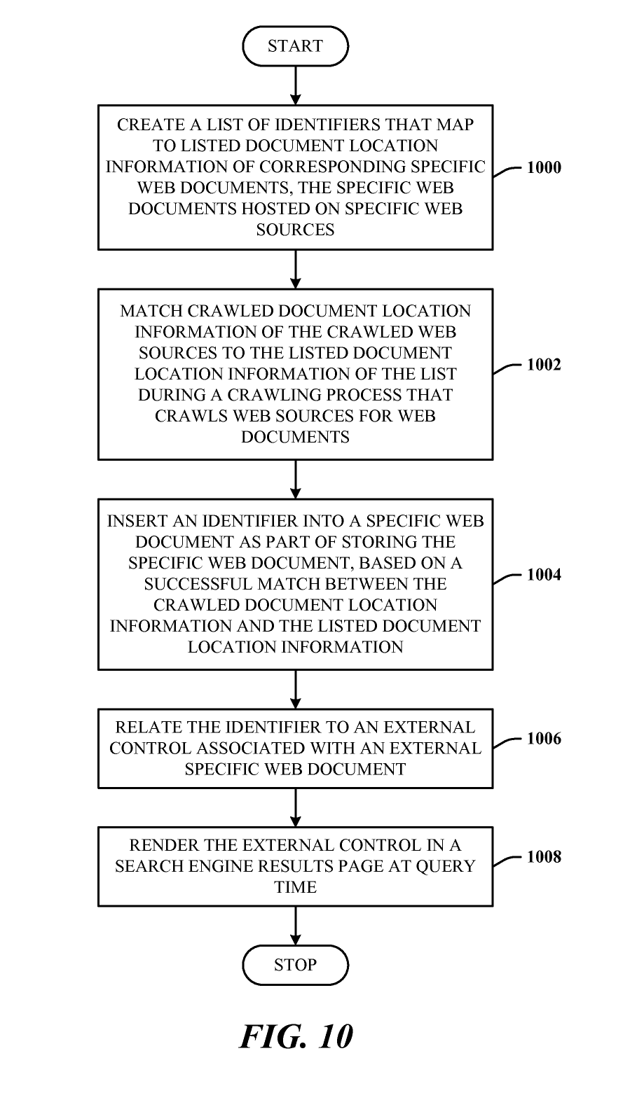

FIG. 10 illustrates an alternative method in accordance with the disclosed architecture. At 1000, a list of identifiers that map to listed document location information of corresponding specific web documents is created. The specific web documents are hosted on specific web sources. At 1002, crawled document location information of the crawled web sources is matched to the listed document location information of the list during a crawling process that crawls web sources for web documents. At 1004, an identifier is inserted into a specific web document as part of storing the specific web document, based on a successful match between the crawled document location information and the listed document location information. At 1006, the identifier is related to an external control associated with an external specific web document. At 1008, the external control is rendered in a search engine results page at query time.

The method can further comprise visually pushing aside search result elements of the search result in response to selecting the external control, to present other content, and visually pushing aside search result elements of the search result in response to selecting yet another control associated with the other content to render another search results page that presents still other content.

The method can further comprise both detecting and rendering the identifier at query time. The method can further comprise instructing a browser to render the external control as an inline frame within the search engine results page, the inline frame for document embedding. The method can further comprise including the identifier in the document resource location information, which is a uniform resource locator. The method can further comprise indexing the identifier into a web index.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

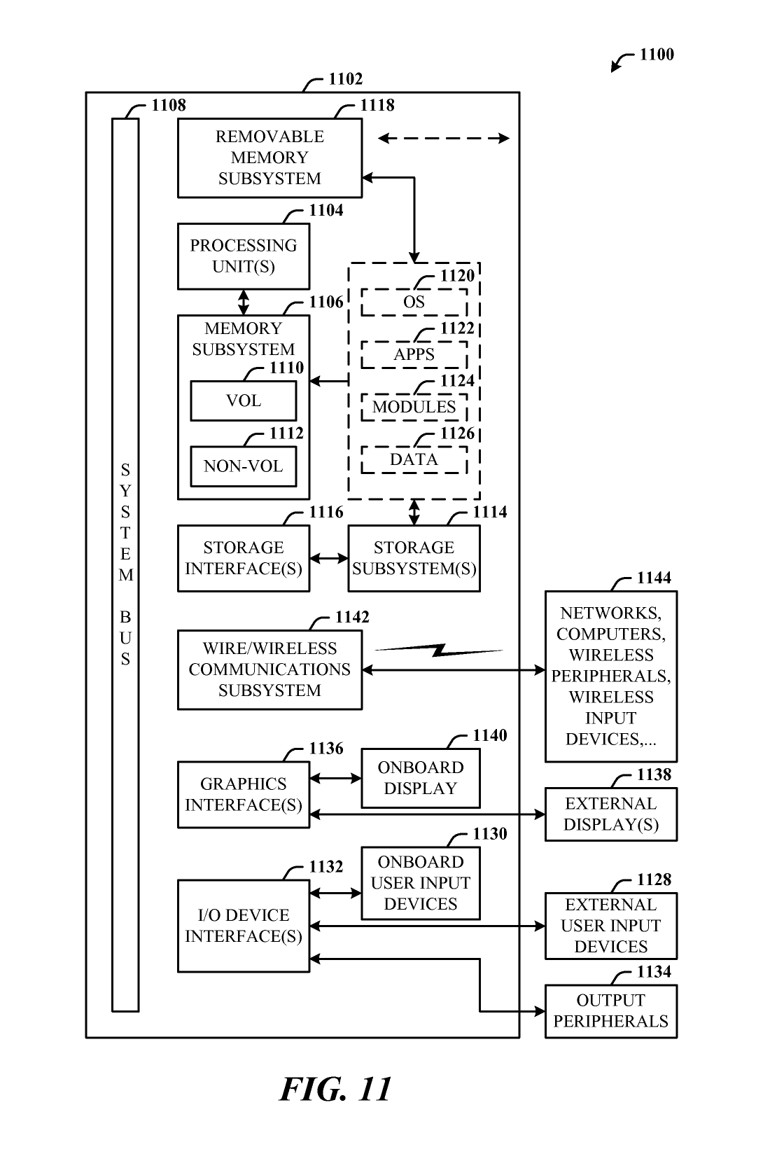

Referring now to FIG. 11, there is illustrated a block diagram of a computing system 1100 that executes the embedding of externally hosted content in a search engine results page in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 11 and the following description are intended to provide a brief, general description of the suitable computing system 1100 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1100 for implementing various aspects includes the computer 1102 having processing unit(s) 1104 (also referred to as microprocessor(s) and processor(s)), a computer-readable storage such as a system memory 1106, and a system bus 1108. The processing unit(s) 1104 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 1102 can be one of several computers employed in a datacenter and/or computing resources (hardware and/or software) in support of cloud computing services for portable and/or mobile computing systems such as cellular telephones and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 1106 can include computer-readable storage (physical storage media) such as a volatile (VOL) memory 1110 (e.g., random access memory (RAM)) and non-volatile memory (NON-VOL) 1112 (e.g., ROM, EPROM, EEPROM, etc.). A basic input/output system (BIOS) can be stored in the non-volatile memory 1112, and includes the basic routines that facilitate the communication of data and signals between components within the computer 1102, such as during startup. The volatile memory 1110 can also include a high-speed RAM such as static RAM for caching data.

The system bus 1108 provides an interface for system components including, but not limited to, the system memory 1106 to the processing unit(s) 1104. The system bus 1108 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1102 further includes machine readable storage subsystem(s) 1114 and storage interface(s) 1116 for interfacing the storage subsystem(s) 1114 to the system bus 1108 and other desired computer components. The storage subsystem(s) 1114 (physical storage media) can include one or more of a hard disk drive (HDD), a magnetic floppy disk drive (FDD), solid state drive (SSD), and/or optical disk storage drive (e.g., a CD-ROM drive DVD drive), for example. The storage interface(s) 1116 can include interface technologies such as EIDE, ATA, SATA, and IEEE 1394, for example.

One or more programs and data can be stored in the memory subsystem 1106, a machine readable and removable memory subsystem 1118 (e.g., flash drive form factor technology), and/or the storage subsystem(s) 1114 (e.g., optical, magnetic, solid state), including an operating system 1120, one or more application programs 1122, other program modules 1124, and program data 1126.

The operating system 1120, one or more application programs 1122, other program modules 1124, and/or program data 1126 can include entities and components of the system 100 of FIG. 1, entities and components of the system 200 of FIG. 2, entities and components of the system 300 of FIG. 3, entities and components of the system 400 of FIG. 4, entities and components of the user interface 504 of FIG. 5, entities and components of the user interface 504 of FIG. 6, entities and components of the user interface 504 of FIG. 7, entities and flow of the diagram 800 of FIG. 8, and the methods represented by the flowcharts of FIGS. 9 and 10, for example.

Generally, programs include routines, methods, data structures, other software components, etc., that perform particular tasks or implement particular abstract data types. All or portions of the operating system 1120, applications 1122, modules 1124, and/or data 1126 can also be cached in memory such as the volatile memory 1110, for example. It is to be appreciated that the disclosed architecture can be implemented with various commercially available operating systems or combinations of operating systems (e.g., as virtual machines).

The storage subsystem(s) 1114 and memory subsystems (1106 and 1118) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that does not employ propagated signals, can be accessed by the computer 1102, and includes volatile and non-volatile internal and/or external media that is removable or non-removable. For the computer 1102, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 1102, programs, and data using external user input devices 1128 such as a keyboard and a mouse, as well as by voice commands facilitated by speech recognition. Other external user input devices 1128 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1102, programs, and data using onboard user input devices 1130 such a touchpad, microphone, keyboard, etc., where the computer 1102 is a portable computer, for example.

These and other input devices are connected to the processing unit(s) 1104 through input/output (I/O) device interface(s) 1132 via the system bus 1108, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1132 also facilitate the use of output peripherals 1134 such as printers, audio devices, camera devices, and so on, such as a sound card and/or onboard audio processing capability.

One or more graphics interface(s) 1136 (also commonly referred to as a graphics processing unit (GPU)) provide graphics and video signals between the computer 1102 and external display(s) 1138 (e.g., LCD, plasma) and/or onboard displays 1140 (e.g., for portable computer). The graphics interface(s) 1136 can also be manufactured as part of the computer system board.

The computer 1102 can operate in a networked environment (e.g., IP-based) using logical connections via a wired/wireless communications subsystem 1142 to one or more networks and/or other computers. The other computers can include workstations, servers, routers, personal computers, microprocessor-based entertainment appliances, peer devices or other common network nodes, and typically include many or all of the elements described relative to the computer 1102. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1102 connects to the network via a wired/wireless communication subsystem 1142 (e.g., a network interface adapter, onboard transceiver subsystem, etc.) to communicate with wired/wireless networks, wired/wireless printers, wired/wireless input devices 1144, and so on. The computer 1102 can include a modem or other means for establishing communications over the network. In a networked environment, programs and data relative to the computer 1102 can be stored in the remote memory/storage device, as is associated with a distributed system. It will be appreciated that the network connections shown are exemplary and other means of establishing a communications link between the computers can be used.

The computer 1102 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a matching component that matches crawled document location information of crawled web sources to listed document location information of a list of listed document-location-information-to-identifier pairs;
an insertion component that inserts an identifier into a specific web document as part of storing the specific web document, based on a successful match between the crawled document location information and the listed document location information; and
a microprocessor that executes computer-executable instructions associated with at least one of the list component, matching component, or insertion component.

2. The system of claim 1, the further comprising a list component for creating the list of pairs of corresponding specific web documents, the specific web documents hosted on specific web sources.

3. The system of claim 1, further comprising a rendering component that renders an external control in a search engine results page when the identifier is detected at query time.

4. The system of claim 3, wherein the rendering component pushes aside elements of a search result on a search engine results page to render content associated with the specific web document, the search result associated with the external control.

5. The system of claim 3, wherein the rendering component pushes aside elements of a search result on a search engine results page to render another search results page of content.

6. The system of claim 1, wherein the matching component is part of a web indexing component that indexes the identifier into an index of web documents.

7. A method, performed by a computer system executing machine-readable instructions, the method comprising acts of:
creating a list of identifiers that map to listed document location information of corresponding specific web documents, the specific web documents hosted on specific web sources;
crawling web sources for web documents;
matching crawled document location information of the crawled web sources to the listed document location information of the list;
inserting an identifier into a specific web document as part of storing the specific web document, based on a successful match between the crawled document location information and the listed document location information; and
configuring at least one processor to perform at least one of the acts of creating, crawling, matching, or inserting.

8. The method of claim 7, further comprising relating the identifier to an external control associated with an external specific web document.

9. The method of claim 8, further comprising rendering the external control in a search engine results page when the identifier is detected at query time.

10. The method of claim 9, further comprising employing the identifier in association with the listed document location information to link the control to interactive content hosted on the specific web source.

11. The method of claim 8, further comprising visually pushing aside other content of a search result to render the specific web document associated with the identifier.

12. The method of claim 8, further comprising visually pushing aside the other content and the specific web document to render still other content in association with the search result based on selection of still another control.

13. The method of claim 8, further comprising visually pushing aside other content of a search result to render another search results page.

14. A method performed by a computer system executing machine-readable instructions, the method comprising:
creating a list of identifiers that map to listed document location information of corresponding specific web documents, the specific web documents hosted on specific web sources;
matching crawled document location information of the crawled web sources to the listed document location information of the list during a crawling process that crawls web sources for web documents;
inserting an identifier into a specific web document as part of storing the specific web document, based on a successful match between the crawled document location information and the listed document location information;
relating the identifier to an external control associated with an external specific web document;
rendering the external control in a search engine results page at query time; and
configuring at least one processor to perform at least one of the acts of creating, matching, inserting, relating, or rendering.

15. The method of claim 14, further comprising visually pushing aside search result elements of the search result in response to selecting the external control, to present other content.

16. The method of claim 15, further comprising visually pushing aside search result elements of the search result in response to selecting yet another control associated with the other content to render another search results page that presents still other content.

17. The method of claim 14, further comprising both detecting and rendering the identifier at query time.

18. The method of claim 14, further comprising instructing a browser to render the external control as an inline frame within the search engine results page, the inline frame for document embedding.

19. The method of claim 14, further comprising including the identifier in the document resource location information, which is a uniform resource locator.

20. The method of claim 14, further comprising indexing the identifier into a web index.
